(19) United States
(12) Patent Application Publication
(10) Pub. No.: US 2021/0314293 A1
(43) Pub. Date: Oct. 7, 2021

(54) METHOD AND SYSTEM FOR USING TUNNEL EXTENSIBLE AUTHENTICATION PROTOCOL (TEAP) FOR SELF-SOVEREIGN IDENTITY BASED AUTHENTICATION

(71) Applicant: HEWLETT PACKARD ENTERPRISE DEVELOPMENT LP, Houston, TX (US)

(72) Inventors: ABILASH SOUNDARARAJAN, Bangalore (IN); TIMOTHY CAPPALLI, Boston, MA (US)

(21) Appl. No.: 16/838,849

(22) Filed: Apr. 2, 2020

(51) Int. Cl. H04L 29/06; H04L 9/30; H04W 12/06; H04W 12/08

(52) U.S. Cl. CPC H04L 63/029; H04L 63/08; H04L 9/30; H04L 2209/38; H04W 12/06; H04W 12/08; H04L 63/10

(57) ABSTRACT

Systems and methods enabling network authentication using a Blockchain-based construct of self-sovereign identity are described. The disclosed self-sovereign identity-based network authentication method system and methods allow for a peer to submit a distributed identity (DID) or a verifiable claim as a credential to a TEAP server for authentication within a TEAP framework. Disclosed system and methods integrate Blockchain and TEAP in a manner that does not require overhauling the authentication standard, or creating a completely new authorization framework or new TEAP mechanism.

### BACKGROUND

As network communication technology continues to evolve and grow at a rapid pace, it is becoming increasingly more important for networking systems to focus on improving security, such as the procedures used for verification and authentication. For instance, the user of a mobile device, such as a cell phone (e.g., smart phone) may be required to submit credentials, or a form of identification, in order to use their phone's wireless connectivity to securely connect to a wireless network in a manner that may be susceptible to interception. Accordingly, emerging network authorization mechanisms, such as Tunnel Extensible Authentication Protocol (TEAP), are progressing towards providing more secure, vendor neutral, multi-purpose and standardized authentication schemes.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example of a Blockchain-based Internet of Things (IoT) system that integrates the use of self-sovereign identities (e.g., distributed identity, verifiable claims) for network authentication via Tunnel Extensible Authentication Protocol (TEAP), according to some embodiments.

FIG. 2A is an operational flow diagram illustrating an example of a process for self-sovereign identity-based network authentication using a distributed identity (DID) corresponding to a peer for network authentication via TEAP, according to some embodiments.

FIG. 2B is a continuation of the operational flow diagram in FIG. 2A illustrating an example of a process for self-sovereign identity-based network authentication using a distributed identity (DID) corresponding to a peer for network authentication via TEAP, according to some embodiments.

FIG. 3A is an operational flow diagram illustrating an example of a process for self-sovereign identity-based network authentication using a verifiable claim corresponding to a peer for network authentication via TEAP, according to some embodiments.

FIG. 3B is a continuation of the operational flow diagram in FIG. 3A illustrating an example of a process for self-sovereign identity-based network authentication using a verifiable claim corresponding to a peer for network authentication via TEAP, according to some embodiments

FIG. 4 illustrates an example computer system that may be used in implementing verifiable claims for physical assets, relating to the embodiments of the disclosed technology.

The figures are not exhaustive and do not limit the present disclosure to the precise form disclosed.

### DETAILED DESCRIPTION

Systems and techniques, as disclosed herein, enable network authentication using the Blockchain-based construct of self-sovereign identity, such as a decentralized identity. Thus, self-sovereign identities act as a type of credential that can be used for network authentication, as opposed to relying on identifies that are commonly used in more traditional network authentication schemes (e.g., usernames and passwords) which may be more susceptible to security threats. The disclosed systems and techniques achieve this self-sovereign identity-based network authentication by leveraging the authentication frameworks supported by Extensible Authentication Protocol (EAP) and Tunnel Extensible Authentication Protocol (TEAP), which are generally characterized as having design flexibility and adaptability for a wide range of practical applications. Although there are advancements currently being made in the realm of Blockchain, self-sovereign identity specifically, there are no existing authentication standards, such as EAP, that integrate Blockchain with network authentication to achieve an approach that is based primarily on self-sovereign identity. Moreover, the network authentication scheme disclosed herein utilizes the emerging technology of self-sovereign identity and can be realized within a framework that is already established by EAP, in manner that does not require an overhaul of the standard or the creation of a completely new authorization framework or new EAP mechanism.

As referred to herein, Extensible Authentication Protocol (EAP) is a protocol for wireless networks that expands on authentication methods used by the Point-to-Point Protocol (PPP), a protocol often used when connecting a computer to the Internet. EAP can support multiple authentication mechanisms, such as token cards, smart cards, certificates, one-time passwords, and public key encryption authentication. Further, as referred to herein, Tunnel Extensible Authentication Protocol (TEAP) is a tunnel-based EAP method that enables secure communication between a peer and a server by using the Transport Layer Security (TLS) protocol to establish a mutually authenticated tunnel. Within the tunnel, type-length-value (TLV) objects are used to convey authentication-related data between the EAP peer and the EAP server.

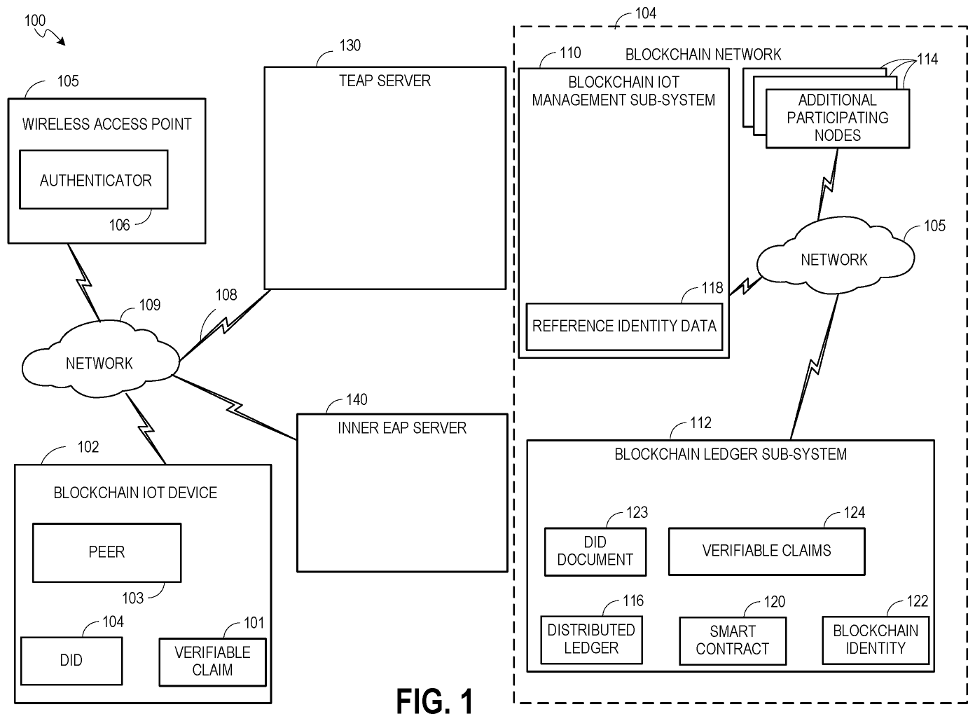

Referring now to the drawings, in FIG. 1, an example of a Blockchain-based IoT system 100 (hereinafter referred to as a Blockchain IoT system 100) that implements self-sovereign identity-based network authentication techniques is illustrated. The system 100 is shown to include: a peer 103 shown as Blockchain IoT device 102; an authenticator 106 shown as wireless access point (WAP) 105; a TEAP server 130; an Inner EAP server/Relaying server 140; and a Blockchain network 104 which includes a Blockchain IoT management sub-system 110, and Blockchain ledger sub-system 112. It should be appreciated that the entities described above are logical entities and may or may not correspond to separate physical network components. For example, the TEAP server 130 and Inner EAP method server 140 might be a combined in a single entity; the authenticator 106 and TEAP server 130 might be a single entity; or the functions of the authenticator 106, TEAP server 130, and inner EAP server 140 might be combined into a single physical device. As an example, some IEEE 802.11 deployments place the authenticator 106 in an access point (AP) 105 (as shown), while a RADIUS server may provide the TEAP server 130 and inner EAP server 140 components. The diagram in FIG. 1 illustrates the division of labor among entities in a general manner and shows how a distributed system might be constructed; however, other systems might be realized in a different manner.

FIG. 1 also shows an example communication between the Blockchain IoT device 102 acting as peer 103 and the WAP 105 acting as authenticator 106. In the illustrated example, the Blockchain IoT device 103 is in communication with the WAP 105 in an attempt to be authenticated, and as a result gain access to network 109 via Wi-Fi. As used herein, Wi-Fi is a family of radio technologies that is commonly used for the wireless local area networking (WLAN) of devices which is based around the IEEE 802.11 family of standards. Wi-Fi uses multiple parts of the IEEE 802 protocol family and is designed to seamlessly interwork with its wired sister protocol Ethernet. Thus, in this example, the Blockchain IoT device 102 can be any mobile device with wireless connectivity capabilities for use Wi-Fi technologies. For instance, the Blockchain IoT device 102 can be implemented as a laptop, smartphone, mobile computing device, mobile telephone, tablet, digital audio players, and the like.

As illustrated in FIG. 1, the Blockchain IoT device 105 can attempt to connect to the network 109, which may be a corporate network, through WAP 105 using a wireless technology, such as Wi-Fi. The WAP 105 can further provide wireless access to wide area networks (WANs), such as the Internet. The WAP 105 can have capabilities of an access point, including acting as the authenticator 106 which allows the Blockchain IoT device 102 access to the network 109 upon being successfully authenticated.

Further, as will be described in greater detailed below, the Blockchain IoT device 102 is Blockchain-enabled. Thus, the Blockchain IoT device 102 is enabled to have connectivity to the Blockchain network 104, and to employ mechanisms that are related to Blockchain, namely self-sovereign identity. The World Wide Web Consortium (W3C) is standardizing a format of digitally-signed credentials, while public Blockchains provide decentralized registration and discovery of the public keys needed to verify digital signatures. These two factors have contributed to an emergence of self-sovereign identity, which can be generally described as a portable digital identity that does not depend on any central authority, being that it is self-maintained (by the identity holder), and self-controlled (by the identity holder). With respect to the system 100, the blockchain IoT device 102 may be associated with an end user, who is further associated with its own self-sovereign identity. The end user being the holder of a self-sovereign identity is illustrated in FIG. 1 by Blockchain IoT device 102 having a distributed identity (DID) 104 and verifiable claim 101 provisioned thereon. In an embodiment, the Blockchain IoT device 102 can have an integrated software application (app) that has the DID 104 and/or verifiable claim 101 installed thereon.

In accordance with the disclosed self-sovereign identity-based authentication techniques, the Blockchain IoT device 102 has the capability to submit its self-sovereign identity, for example either its DID 104 or a verifiable claim 101, to be authenticated for access to the network 109. By using self-sovereign identity, the user of the Blockchain IoT device 102 is not required to submit more traditional types of credentials (e.g., username, passwords) that must be maintained and governed by a centralized authority. As an example, the Blockchain IoT device 102 can be registered to a municipality or city. Therefore, the Blockchain IoT device 102 can have a DID 104 with a corresponding public key that is related to this municipality. The Blockchain network 104, in this example, can also be published and maintained by the municipality. Companies within the municipality can also be participants in the Blockchain. According to the embodiments, the Blockchain IoT device 102 can use its DID 104 for authentication and ultimately to connect to any network within the municipality, including the separate networks provided by each company within the municipality. This provides improved efficiencies in comparison to conventional network authentication mechanisms, where the user of the Blockchain IoT device 102 may need separate and distinct credentials to access each of the individual networks. In this example, the self-sovereign identity-based network authentication can also realize other advantages, such as smaller infrastructure and reduced costs.

In order to achieve self-sovereign identity-based network authentication, the example system 100 particularly utilizes TEAP, for instance employing TEAP server 130. TEAP is used to implement existing network authentication mechanisms. For instance, TEAP has served as the framework for various authentication mechanisms, such as digital certificate based authentication, hashing (e.g., MD5) based authentication, and subscriber identification module (SIM)-based authentication. Furthermore, TEAP can be considered an open standard approach, as the TEAP uses different TLV objects to implement the negotiations, schemes, and data used for authentication in a flexible and modular manner. Accordingly, TEAP can be used as a framework for authentication which can be adapted to have different implementations of authentication mechanisms that are suitable for a plethora of different applications. With the benefit of this disclosure, TEAP may be leveraged to implement a self-sovereign identity-based network authentication.

The modularity and flexibility of TEAP lends itself to integration with Blockchain. System 100 discloses interoperability between the Blockchain elements and the TEAP elements in a manner that allows a Blockchain-based identity, namely DID 104 and verifiable claim 101, to be used as a credential within the TEAP ecosystem. As an example, in accordance with TEAP, peer 103 can provide its identity to the TEAP server 130 for authentication. According to the embodiments, the peer 103 can provide its DID 104 (or verifiable claim 101) to the TEAP server 130 for authentication.

Using TEAP nomenclature, as seen in FIG. 1, the peer 103 is considered an EAP peer that is requesting authentication, while authenticator 106 is considered an EAP authenticator providing a service which requires authentication. The TEAP sever 130 can be considered a TEAP authentication server. The TEAP server 130 can have the capabilities of an authentication, authorization, and accounting (AAA) server, and supports TEAP. The Inner EAP server 140 can function as a relay server, or intermediary, between the TEAP server 130 and the Blockchain network 104 having a Blockchain identity module that supports this functionality.

Now, the Blockchain aspects of the system 100 will be described in reference to FIG. 1. As seen in FIG. 1, The Blockchain IoT system 100 may include a Blockchain IoT device 102. The Blockchain network 104 may be coupled to the Blockchain IoT device 102 via a network 109. The network 109 may refer to a medium that interconnects the Blockchain IoT device 102 and the Blockchain network 104. Examples of the network 106 may include, but are not limited to, an Internet Protocol (IP) or non-IP-based local area network (LAN), wireless LAN (WLAN), personal area network (PAN), machine-to-machine networks (M2M), metropolitan area network (MAN), wide area network (WAN), a cellular communication network, and the Internet. Communication over the network 106 may be performed in accordance with various communication protocols such as, but not limited to, Transmission Control Protocol and Internet Protocol (TCP/IP), User Datagram Protocol (UDP), IEEE 802.11, and cellular communication protocols over communication links 108. The communication links 108 may be enabled via a wired (e.g., copper, optical communication, etc.) or wireless (e.g., Wi-Fi®, cellular communication, satellite communication, Bluetooth® communication technologies. In some examples, the network 106 may be enabled via private communication links including but not limited to, communication links established via Bluetooth, cellular communication, optical communication, radio frequency communication, and the like.

Although a Blockchain IoT device 102 is depicted in FIG. 1, the Blockchain IoT system 100 including more than one such Blockchain IoT devices is also envisioned, without limiting the scope of the present disclosure. Examples of the Blockchain IoT device 102 may include, but are not limited to, a radio frequency identification (RFID) tag, an RFID scanner, a Bluetooth device, a Near-Field Communication Reader (e.g., an NFC or Bluetooth reader), a sensor unit, or combinations thereof. In some examples, the Bluetooth device may be a Bluetooth Low Energy (BLE) device or a BLE tag. During operation, the Blockchain IoT device 102 may generate data, hereinafter referred to as an event data. By way of example, Blockchain IoT device 102 may be embodied as a RFID scanner that generates event data representative of particulars associated with an RFID tag being scanned by the RFID scanner. The particulars associated with the RFID tag may include information pertaining to an object (e.g., device, component, machine, etc.) to which the RFID tag is applied. Similarly, in some examples, the Blockchain IoT device 102, when embodied as a Bluetooth reader, may generate an event data that is representative of particulars associated with a Bluetooth device associated with an object.

In some examples, the event data generated by the Blockchain IoT device 102 may be communicated to the Blockchain network 104 via the network 106. The Blockchain IoT device 102 may send the event data to a Blockchain IoT management sub-system 110 (described later) of the Blockchain network 104 when an event occurs. The term “event” as used herein may refer to an act that causes the Blockchain IoT device 102 to generate event data. For example, the event may be an instance wherein the Blockchain IoT device 102, in this example, the RFID scanner, scans the RFID tag, which in turn causes the RFID scanner to generate the event data. In another example, the event may be an instance when the Blockchain IoT device 102 (embodied as a Bluetooth device) generates event data.

In some examples, the Blockchain IoT device 102 may have been assigned an identity. The identity assigned to the Blockchain IoT device 102 may uniquely identify the Blockchain IoT device 102 among other IoT devices (not shown). The term “decentralized identity” as used herein may refer to a self-sovereign identifier provisioned to the Blockchain IoT device 102 without any intervening or centralized administrative authorities. For example, in the Blockchain IoT system 100 of FIG. 1, the decentralized identity may be provisioned to the Blockchain IoT device 102 from the Blockchain network 104 (described later). The decentralized identity may be used by the Blockchain IoT device 102 to present a verifiable claim to the Blockchain network 104. In particular, the Blockchain IoT device 102 may sign or attest to the event data generated by the Blockchain IoT device 102 using its decentralized identity. In some examples, the event data generated by the Blockchain IoT device 102 may include a signature based on its decentralized identity.

In accordance with some aspects of the present disclosure, the decentralized identity may include a public key, a private key, and an attribute corresponding to the Blockchain IoT device 102 issued by the Blockchain network 104 to the Blockchain IoT device 102. The term “attribute” as used herein may refer to one or more additional identification details of the Blockchain IoT device 102 including, but not limited to: a class of the Blockchain IoT device 102; an identification number of the Blockchain IoT device 102; details of a custodian of the Blockchain IoT device 102; a name or identification of an organization in which the Blockchain IoT device 102 is deployed; a country of the organization; a city of the organization; information about a building of the organization in which the Blockchain IoT device 102 is deployed; a floor of the building in which the Blockchain IoT device 102 is deployed; a zone on the floor in which the Blockchain IoT device 102 is deployed; or location coordinates of the Blockchain IoT device 102. In some embodiments, the decentralized identity may be maintained in the form of a Decentralized Identifier Document (DID) that describes how to use that specific decentralized identity.

DID is an identity system developed by the World Wide Consortium (W3C). DIDs are a type of identifier that provides a digital identity that is verifiable, decentralized, and “self-sovereign.” DIDs are designed to enable a controller of the DID to prove its control over it, and are further designed in a decentralized manner. In other words, DIDs are implemented independently of any centralized registry, identity provider, or certificate authority. As a general description, DIDs are Uniform Resource Locators (URLs) that relate a DID subject to a DID document allowing trustable interactions with that subject. DID documents are documents describing how to use that specific DID. Each DID document can express cryptographic material, verification methods, or service endpoints, which provide a set of mechanisms enabling a DID controller to prove control of its DID. Service endpoints enable trusted interactions with the DID subject.

DID is different than identity management systems that are based on centralized authorities (e.g., corporate directory services, certificate authorities, or domain name registries). From the standpoint of cryptographic trust verification, each of these centralized authorities serves as its own root of trust. Centralized systems often requires federated identity management to make their identify management systems work. However, the emergence of distributed ledger technology (DLT) and Blockchain technology provides the opportunity for fully decentralized identity management, which is moving away from federated identity management.

In a decentralized identity system, entities (that is, discrete identifiable units such as, but not limited to, people, organizations, and things) are free to use any shared root of trust. Globally distributed ledgers, decentralized P2P networks, or other systems with similar capabilities, provide the means for managing a root of trust without introducing a centralized authority (or a single point of failure). In combination, DLTs and DID management systems enable any entity to create and manage their own identifiers on any number of distributed, independent roots of trust.

Entities are identified by DIDs, and can authenticate using proofs (for example, digital signatures, privacy-preserving biometric protocols, and so on). DIDs point to DID documents. For example, in FIG. 1 the DID 104 can point to a specific DID document that corresponds to that peer (and its DID 104) from among the DID documents 123 maintained by the Blockchain ledger sub-system 112. DID documents can contain a set of service endpoints for interacting with the entity that the DID identifies (that is, the DID subject). Following the guidelines of Privacy by Design, any entity can have as many DIDs (and corresponding DID documents and service endpoints) as necessary to respect the entity's desired separation of identities, personas, and contexts (in the everyday sense of these words). DID methods are the mechanism by which a DID and its associated DID document are created, read, updated, and deactivated on a specific distributed ledger or network. DID methods are defined using separate DID method specifications. This design eliminates dependence on centralized registries for identifiers as well as centralized certificate authorities for key management, which is the standard in hierarchical PKI (public key infrastructure). In cases where the DID registry is a distributed ledger 116, each entity can serve as its own root authority. This architecture is referred to as DPKI (decentralized PKI).

As noted hereinabove, the Blockchain network 104 may be coupled to the Blockchain IoT device 102 via the network 106. The Blockchain network 104 may be implemented as a public Blockchain network, a private Blockchain network, or a hybrid Blockchain network having combination of both the public Blockchain network and the private Blockchain network. As used herein, the term “public Blockchain network” may refer to a Blockchain network that is accessible to any entity and whereby any entity may participate in a consensus process in the public Blockchain network. A public Blockchain network may also be referred to as a “fully decentralized” Blockchain network. Further, the term “private Blockchain network” as used herein, may refer to a Blockchain network where a limited set of trusted entities participate. In particular, in the private Blockchain network, a permissioned set of participating nodes may participate in the consensus process. By way of example, a consortium of multiple financial institutions may form a private Blockchain network. A right to read Blockchain data from the private Blockchain network may be restricted to trusted participating nodes. The private Blockchain network may also be referred to as a permissioned Blockchain network. Although some examples are described herein with respect to the private Blockchain network, it should be appreciated that the technology disclosed herein may be adapted for use in public or hybrid Blockchain networks.

The Blockchain network 104, as depicted in FIG. 1, may be implemented as a consortium. For example, the Blockchain network 104 may be implemented by an enterprise consortium of companies that operate the Blockchain network 104. By way of example, the Blockchain network 104 may include a plurality of participating nodes, including but not limited to, the Blockchain IoT management sub-system 110, the verifiable claim sub-system 130, a Blockchain ledger sub-system 112, and one or more additional participating nodes 114.

Each of the participating nodes 114 may be a computing node such as a computer, a device including a processor or microcontroller and/or any other electronic component, device or system that performs one or more operations according to one or more programming instructions. Examples of the participating nodes 114 may include, but are not limited to, a desktop computer, a laptop, a ruggedized mobile computer, a smartphone, a server system, a computer appliance, a gateway, a data gathering panel, a remote terminal unit, a programmable logic controller, a workstation, and the like. In the Blockchain network 104, the participating node 114 may be connected to each other via a network 105. In some examples, the network 105 may be analogues to the network 104. In certain examples, the participating node 114 may be connected to each other via the network 104.

Although not shown, each of the participating nodes 114 may include at least one processing resource and a machine readable medium. Non-limiting examples of the processing resource may include a microcontroller, a microprocessor, central processing unit core(s), application-specific integrated circuit (ASIC), a field programmable gate array (FPGA), etc. The machine readable medium may be a non-transitory storage medium, examples of which include, but are not limited to, a random access memory (RAM), a read-only memory (ROM), an electrically erasable programmable read-only memory (EEPROM), a flash memory, a hard disk drive, etc. The processing resource may execute instructions (i.e., programming or software code) stored on the machine readable medium to perform operations desired to be performed by the participating nodes 114. Additionally or alternatively, the processing resource may include electronic circuitry for performing the functionality described herein.

In the Blockchain network 104, some or all of the participating nodes may include a copy of a distributed ledger 116. For convenience of representation, the Blockchain ledger sub-system 112 is shown to include one copy of such distributed ledger 116. As used herein, the term “distributed ledger” may refer to a shared digital ledger that is decentralized and synchronized among the participating nodes 114 distributed across the Blockchain network 104. After a transaction is approved to be written or stored to the distributed ledger 116, the transaction is consented to by at least the majority of the participating nodes 114. The contents of the distributed ledger 116 are synchronized across all the participating nodes 114. Different types of consensus mechanisms may be implemented on the participating nodes 114 to bring in varying levels of processing requirements to achieve agreement amongst the participating nodes 114. Examples of common consensus mechanisms may include, but are not limited to, proof of work, proof of stake, proof of elapsed time, Kafka distributed streaming platform, etc. In some examples, when a new participating node is added to the Blockchain network 104, a copy of the distributed ledger 116 may be downloaded to the newly joined participating node.

In the distributed ledger 116, data is generally stored as a Blockchain of chronologically ordered, back-linked list of data blocks. A number of data blocks in the Blockchain are connected together via use of hashing. For example, when a new block is added to the Blockchain, the new block includes a hash reference such as a hash of a predecessor block. In this manner, several data blocks may be chained together to form a Blockchain and each additional block creates an additional immutable record, which collectively provide security for and validation of the entire Blockchain. This makes it difficult to retroactively alter data stored within the Blockchain without that alteration being detected. A Blockchain may include information about the participating nodes, an owner of a block and content of the block right from the first block to the most recently completed block (also referred to as a latest data block).

In some implementations, the participating nodes 114 in the Blockchain network 104 may be able to write/store transactions on the distributed ledger 116, but not verify transactions. In the example of FIG. 1, the Blockchain IoT management sub-system 110 may be operated as a verifier that verifies the decentralized identity of the Blockchain IoT device 102. In some examples, the Blockchain IoT device 102 may be registered with the Blockchain IoT management sub-system 110. In some examples, during such registration, the Blockchain IoT management sub-system 110 may provision the decentralized identity to the Blockchain IoT device 102. Also, the Blockchain IoT management sub-system 110 may store some of the decentralized identity information of the Blockchain IoT device 102 in a reference identity data 118. For instance, the reference identity data 118 may store decentralized identity of all Blockchain IoT devices registered with the Blockchain IoT management sub-system 110. By way of example, the reference identity data 118 may include a reference public key, a reference attribute, or both corresponding to each of the registered Blockchain IoT devices. The Blockchain IoT devices that are registered with the Blockchain IoT management sub-system 110 are hereinafter referred to as valid devices from which the Blockchain IoT management sub-system 110 can accept the event data.

During operation, the Blockchain IoT management sub-system 110 may receive the event data from the Blockchain IoT device 102 via the network 106. In some examples, in order to ensure that the event data are sent by a valid Blockchain IoT device, the Blockchain IoT management sub-system 110 may verify the decentralized identity contained in the received event data. In order to verify the decentralized identity, the Blockchain IoT management sub-system 110 may extract a signature from the received event data and validate the signature using the reference identity data 118. In some examples, the Blockchain IoT management sub-system 110 may validate the signature using the reference public key corresponding to the Blockchain IoT device 102. If decentralized identity of the Blockchain IoT device 102 is successfully verified, the Blockchain IoT management sub-system 110 may accept the event data received from the Blockchain IoT device 102. Alternatively, the Blockchain IoT management sub-system 110 may reject or discard the event data received from the Blockchain IoT device 102.

In certain instances, the event data received from the Blockchain IoT device 102 may be unstructured, may include additional data that is irrelevant to a given business application or utility, and/or may contain redundant information. Therefore, upon successful verification of the decentralized identity of the Blockchain IoT device 102, the Blockchain IoT management sub-system 110 may process the event data received from the Blockchain IoT device 102 to generate processed event data. In some examples, to facilitate such processing of the event data, the Blockchain IoT management sub-system 110 may remove duplicate entries from the event data. Accordingly, after removal of the duplicate entries from the event data by the Blockchain IoT management sub-system 110, the resulting processed event data only include unique entries.

Further, in some other examples, to facilitate the processing of the event data, the Blockchain IoT management sub-system 110 may remove a predetermined type of information from the event data thereby retaining at least some contextual information. For instance, the Blockchain IoT management sub-system 110 may remove the predetermined type of information such as any additional information that is irrelevant to the given business application or utility. For example, if a business application requires only the location of an RFID tag to be stored in the distributed ledger 116, the Blockchain IoT management sub-system 110 may remove any data other than the location information of the RFID tag from the received event data. In another example, if the Blockchain IoT device 102 is a sensor that can sense various parameters such as a temperature, a pressure, a humidity, and a carbon dioxide content in a facility premises, the Blockchain IoT device 102 may generate event data that includes information on all of these parameters. Upon receipt of the event data from the sensor unit, and after successful verification of the decentralized identity of the sensor unit, the Blockchain IoT management sub-system 110 may remove information regarding the pressure and the carbon dioxide content from the received event data if only temperature and humidity related information are desired to be retained. Therefore, once any such irrelevant additional information is removed, the resulting processed event data may include a desired contextual information.

Furthermore, in certain examples, to facilitate the processing of the event data, the Blockchain IoT management sub-system 110 may arrange parameters contained in the event data in a predefined template, wherein the processed event data includes the event data arranged in the predefined template. By way of example, if the predefined template includes the parameters to be listed in a particular order, the Blockchain IoT management sub-system 110 may arrange the parameters in the particular order. For instance, if the predefined template requires the humidity information to be presented after the temperature information, the Blockchain IoT management sub-system 110 may arrange the humidity information after the temperature information in the processed event data. As will be appreciated, the predefined template may be selected to be any template, format, arrangement, and/or order of data as desired by the business application for storing the data in the distributed ledger 116. Although the predefined template as illustrated herein relates to an order of presenting various parameters, any type of predefined template may be chosen without limiting the scope of the present disclosure. During this process Blockchain IoT Management sub-system 110 may use the public key of the Blockchain IoT device to validate the signature of the event data, and once it creates the processed event data as per business needs it may sign the processed event data with its private key.

In the example of FIG. 1, the Blockchain IoT management sub-system 110 is described as performing the functionalities of verifying the decentralized identity and processing the event data. In some other examples, while the Blockchain IoT management sub-system 110 may perform one of the two functionalities (e.g., processing the event data), the remaining other functionality (e.g., verifying the decentralized identity) may be performed by a different participating node (e.g., one of the additional participating nodes 114 or the Blockchain ledger sub-system 112), without limiting the scope of the present disclosure.

In accordance with some aspects of the present disclosure, the Blockchain IoT management sub-system 110 may communicate the processed event data to the Blockchain ledger sub-system 112. The Blockchain ledger sub-system 112 may need to verify the processed event data for it to be stored in the distributed ledger 116. In some examples, the Blockchain ledger sub-system 112 may perform an authorization check for the one or both of the Blockchain IoT device 102 or the Blockchain IoT management sub-system 110 based on the identities of the Blockchain IoT device 102 or the Blockchain IoT management sub-system 110, and parameters contained in the processed event data. In some examples, the Blockchain ledger sub-system 112 may perform such authorization check to select a function (hereinafter referred to as a smart contract function) of a smart contract 120 corresponding to one or more of the Blockchain IoT device 102, the Blockchain IoT management sub-system 110, and the parameters contained in the processed event data.

In some examples, the Blockchain ledger sub-system 112 may use identity information stored in a Blockchain identity 122 to perform the authorization of the Blockchain IoT device 102 and the Blockchain IoT management sub-system 110. The Blockchain identity 122 may include identity information (i.e., decentralized identities) corresponding to all devices, parties, and systems that can communicate with the Blockchain ledger sub-system 122. In some examples, the reference identity data 118 stored in the Blockchain IoT management sub-system 110 may provide reference to the identity information stored in the Blockchain ledger sub-system 122. In certain other examples, the reference identity data 118 may be downloaded by the Blockchain IoT management sub-system 110 from the Blockchain identity 122. As previously noted, the identity information such as the decentralized identity may also include attributes corresponding to a given device.

The Blockchain ledger sub-system 112 may allow the receipt of the processed event data from a Blockchain IoT management sub-system 110 or the Blockchain IoT device 102 that are authorized for a given context. For example, if a Blockchain IoT device 102 is authorized for use in scanning RFID tags located in the paint shop of the automobile factory, the Blockchain ledger sub-system 112 may authorize such a Blockchain IoT device 102 if associated processed event data corresponds to the paint shop of the automobile factory.

As noted earlier, the Blockchain ledger sub-system 112 may perform such an authorization check to select the smart contract function, where the smart contract 120 corresponds to one or more of one or more of the Blockchain IoT device 102, the Blockchain IoT management sub-system 110, and the parameters contained in the processed event data. The term “smart contract” as used herein may refer to processor-executable code residing in a Blockchain network such as the Blockchain network 104. The smart contract 120 automates execution of transactions between trusted parties (i.e., parties that have proved their credentials) based on processor executable contract terms. Transactions that happen via the smart contract 120 are processed on the Blockchain network 104, without any intermediator. In the present scenario, in some examples, the smart contract 120 may include various program instructions—execution of which may verify if the processed event data received from the Blockchain IoT management sub-system 110 meets a desired criteria. In some examples, the processed event data may include values of one or more parameters. The desired criteria may require the values of such parameters being in a corresponding predetermined range, the values of the parameters being lower than a corresponding minimum threshold values, or the values of the parameters being higher than a corresponding maximum threshold values. In some examples, the smart contract 120 may include smart contract functions for various businesses and business contexts that are agreed upon by all the participating nodes 110, 112, and 114 of the Blockchain network 104.

In some examples, the Blockchain ledger sub-system 112 may select a smart contract function relevant to one or more of the Blockchain IoT device 102, the Blockchain IoT management sub-system 110, or parameters contained in the processed event data. Further, the Blockchain ledger sub-system 206 may execute the selected smart contract function, thereby performing the verification of the processed event data for proceeding to store the event data in the distributed ledger 116.

Upon successful verification of the processed event data as noted hereinabove, the Blockchain ledger sub-system 112 may store the processed event data in a distributed ledger 116. In some examples, the Blockchain ledger sub-system 112 may require consent from all or at least a majority of the participating nodes 110, 112, 114 for storing the processed event data in the distributed ledger 116. For example, upon successful verification of the processed event data, the Blockchain ledger sub-system 112 may determine whether consensus for storing the processed event data was reached among participating nodes 110, 112, 114 in the Blockchain network 104. Different types of consensus mechanisms or programs may be used by the participating nodes 110, 112, 114 to implement varying levels of processing requirements to agree on a transaction (e.g., a request for storing the processed event data in the present example) amongst the participating nodes 110, 112, and 114 in the Blockchain network 104. Examples of the consensus mechanisms may include, but are not limited to, proof of work, proof of stake, proof of elapsed time, or Kafka.

Upon successful consensus among the participating nodes 114, the Blockchain ledger sub-system 112 may store the processed event data as a record or block in the distributed ledger 116. In some examples, the Blockchain ledger sub-system 112 may store the processed event data in the distributed ledger 116 along with a verifiable claim 131 or verifiable credentials associated with the Blockchain ledger sub-system 112 to prove that the Blockchain ledger sub-system 112 possesses verifiable credentials with certain characteristics.

In some examples, the information in the processed event data to be stored in the Blockchain may include contents related to the processed event data, a cryptographic hash value of the content of the processed event data, a metadata corresponding to the processed event data, a cryptographic hash value of the metadata, or combinations thereof. Data blocks in the Blockchain are connected together via use of hashing. For example, when a new block is added to the Blockchain, the new block includes a hash reference such as a hash of a predecessor block. In this manner, the several data blocks may be chained together to form a Blockchain and each additional block creates additional security for a validity of the entire Blockchain. This makes it difficult to retroactively alter data stored within the Blockchain without that alteration being detected. A Blockchain has complete information about the participating nodes, an owner of a block and content of the block right from the first block to the most recently completed block (also referred to as a latest data block). Accordingly, a Blockchain provides high security and has a lower probability of being breached unnoticed.

The Blockchain ledger sub-system 112 is configured to create, validate, and submit a specific type of data on the Blockchain IoT system 100, such as DID documents 123 verifiable claims 124. FIG. 1 illustrates the Blockchain ledger sub-system 112 as storing and managing verifiable claims 124 (or verifiable credentials), allowing the sub-system 112 to control authentication, transactions and execution of smart contract 120 with respect to a certain context (as defined by the verifiable claim). Additionally, the Blockchain sub-system 112 is configured to perform the techniques used to validate, create, and deployed verifiable claim 124, as disclosed herein. In particular, the verifiable claim 124 and information relating to the creation, validation, and deployment of the verifiable claim 124 may be stored as a block in a Blockchain of chronologically ordered, back-linked list of data blocks.

Generally, a verifiable claim is a statement that ties a subject to a particular context. Similarly, the verifiable claim 124 in the Blockchain ledger sub-system 112 can be defined such that a peer 103 is tied to a particular context for being authenticated. For instance, referring back to the above example, the network 109 may be restricted for use by residents of a certain municipality. In this case, authenticating the peer 103 is predicated on the end user providing proof to authenticator 106 that they are a person who lives in the municipality owning network 109 (e.g., address that is in a certain city, or town). In an example where authentication uses verifiable claims for authentication, the peer 103 would only be required to provide its verifiable claim that they are a resident of the appropriate municipality. Verifiable claims can be signed by the issuer, which is the municipality in this case. Because DID have an associated public-private key pair, a user having a DID should be able to digitally issue and sign verifiable claims and other documents. As long as the verifier has the DID of the issuer (which in most cases is contained in the credential itself), it is a simple matter to look up the issuer's public key on the Blockchain and verify the signature on the claims.

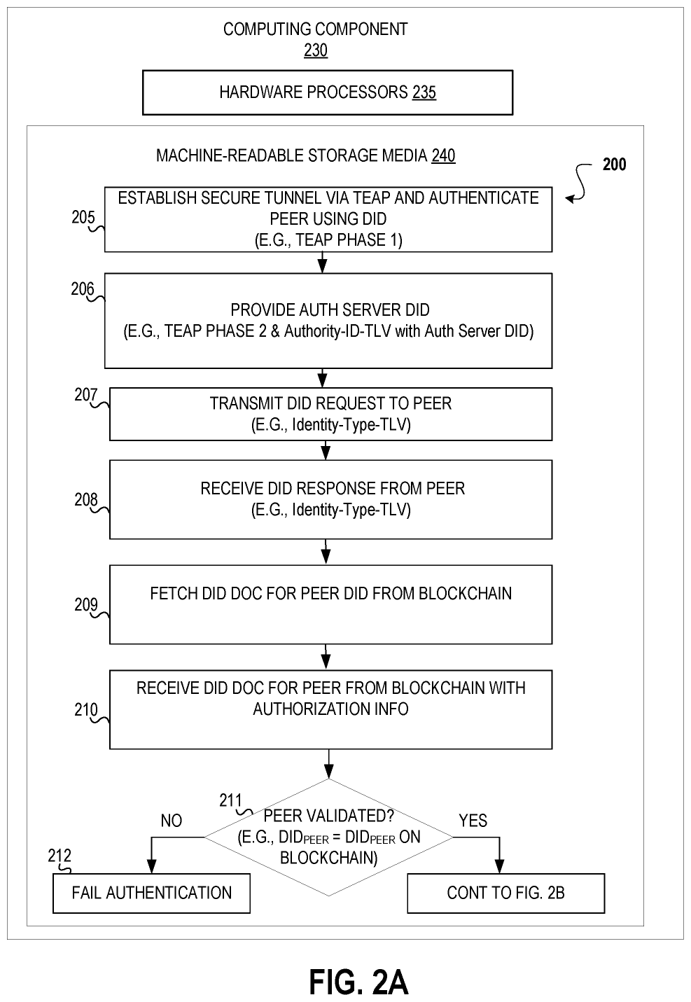

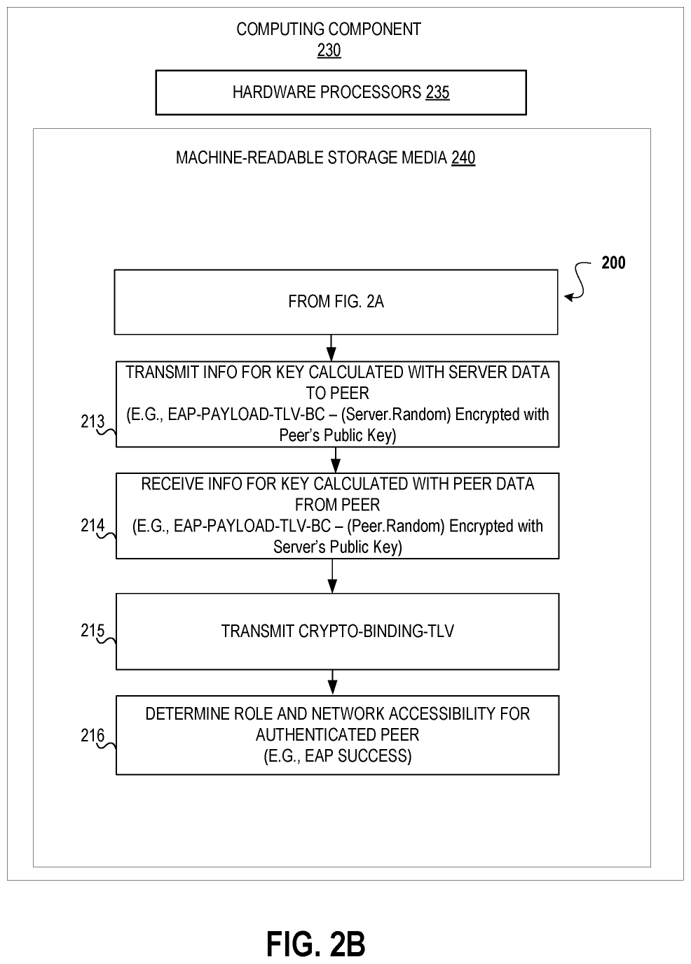

According to the embodiments, the verifiable claim 124 are communicated via the Blockchain network 104, and can be maintained on the distributed ledger 116. With verifiable claim 124 on the distributed ledger 116, the claims are accessible to other participating nodes 114 on the Blockchain and/or other Blockchain IoT devices (not shown). Furthermore, as will be described in further detail, the disclosed techniques allow verifiable claim 124 that corresponding to a peer 103, such as Blockchain IoT device 102 to be used during authentication. Additionally, FIG. 1 shows a DID document 123 being maintained by the Blockchain ledger sub-system 112. As described in detail with reference to FIGS. 2A-2B, for example, the DID document corresponds to a peer 103 in a manner that can be used to verify the peer's authentication in the self-sovereign identity-based network authentication techniques. The DID document 123 can reside on the distributed ledger 116 as a document or transaction that

In the example of FIG. 1, the functionalities of verification of the decentralized identity, processing of the event data, verification of the processed event data, and storage of the processed event data are shown to be performed by different participating nodes 114. The operations performed by the Blockchain IoT management sub-system 110, the Blockchain ledger sub-system 112, and the verifiable claim sub-system 130 may also be performed on a single participating node without limiting the scope of the present disclosure.

The Blockchain IoT device 102 in accordance with some aspects of the present disclosure is registered with the Blockchain IoT management sub-system 110 and is provisioned the decentralized identity from the Blockchain IoT management sub-system 110. Therefore, once the decentralized identity in the event data received from such Blockchain IoT device 102 is verified, the Blockchain IoT device 102 may be considered trusted and the event data can be accepted for further processing. Moreover, the Blockchain IoT management sub-system 110 in the proposed Blockchain network 104, in accordance with some aspects of the present disclosure, processes the received event data to generate the processed event data. Various processing that are performed by the Blockchain IoT management sub-system 110 may include removing duplicate entries from the event data, and/or arranging parameters contained in the event data in a predefined template, and/or removing a predetermined type of information from the event data thereby retaining at least some contextual information of the event data. Furthermore, the Blockchain-based IoT system 100 is configured to allow the Blockchain IoT device 102 to use self-sovereign identity, such as a DID, as a credential to the WAP 105 for access to the communication network. The TEAP server 130 can establish a secure tunnel to the Blockchain IoT device 102 via TEAP (after initial connection with the WAP 105). This secure tunnel can then be used for exchanging data, for instance between the Blockchain IoT device 102 and the TEAP sever 130, during authentication. The TEAP server 103 can transmit a request to the Blockchain IoT device 102 for its corresponding DID as a credential for authentication. By verifying the DID from the Blockchain IoT device 102 against the DID document 123 on the Blockchain network 104, the TEAP server 130 can authenticate the Blockchain IoT device 103 for access to the communication network 109.

Referring now to FIGS. 2A-2B, an example of a process 200 for performing network authentication using a self-sovereign identity, namely DID is shown. As previously described, the process 200 can leverage the EAP authentication framework which is frequently used in network and Internet connections. The process 200 uses some of the common functions and “negotiation of authentication” procedures that are support by the EAP authentication framework, while integrating the emerging technology of self-sovereign identity (and Blockchain) to act as a form of credential. This unique integration of EAP (including TEAP) and self-sovereign identity allows the process 200 to operate in a manner that is distinct over commonly used network authentication mechanisms.

The process 200 can involve a peer entity having a self-sovereign identity provisioned thereon, such as a Blockchain IoT device including DID (shown in FIG. 1) that initially contacts an authenticator, such as a WAP, to gain access to a communication network. The communication network may be a secure network that requires an end user to present valid credentials to gain access, such as a corporate network. Process 200 particularly involves the peer entity providing its DID as a credential for access to the communication network. According to an embodiment, the process 200 can be implemented by an authentication server, such as TEAP server (shown in FIG. 1) that is in communication with a Blockchain network. Accordingly, process 200 is illustrated as a series of executable operations stored in a machine-readable storage media 240, and being performed by hardware processors 235 in a computing component 230. Hardware processors 235 execute the operations of process 200, thereby implementing the self-sovereign identity-based network authentication, as described herein.

The process 200 can begin in FIG. 2A at operation 205, where a secure tunnel is established. As previously described, the tunnel established in operation 205 is created in accordance with TEAP mechanisms. However, is should be appreciated that other mechanisms and/or protocols having a degree of flexibility to integrate Blockchain while enabling a secure authenticated tunnel may be used, as deemed appropriate. As a general description, the secure tunnel is used for communicating information that will be used in subsequent steps in the process 200 for authenticating the peer entity. For instance, once the tunnel is established, a second phase (Phase 2 in accordance with TEAP) begins with the peer and server engaging in further conversations to establish the required authentication and authorization policies. In this example, process 200 will be described specifically using the TEAP-based approach. The peer entity does not need to authenticate as part of the TLS exchange but can alternatively be authenticated through additional exchanges carried out in Phase 2. The secure tunnel, created using TEAP, protects peer identity information exchanged during Phase 2 from disclosure outside of the tunnel.

Additionally, in operation 205, it can be determined that the peer is providing its DID as the form of self-sovereign identity to be used for authentication. For example, the TEAP server can query the peer entity to send an indicator which reflects the type of self-sovereign identity that it will submit to be authenticated. Specifically in the example process 200, an indicator can be received and processed by the TEAP server such that the server becomes aware the peer entity will provide a corresponding DID as its identity for authentication. Based on this determination, the TEAP server can be configured to implement a DID-based authentication procedure.

Generally, operation 205 can establish the secure tunnel using a procedure that is similar to Phase 1 operations currently defined in the TEAP standard. In accordance with TEAP, secure communication between the peer entity and an authenticating server is enabled by using the Transport Layer Security (TLS) protocol to establish a mutually authenticated tunnel. Operation 205 may rely on a TLS handshake to establish the authenticated and protected tunnel. A certificate-based TLS handshake can occur in operation 205. In an embodiment, the TEAP server certificate registered in the Blockchain and downloaded by the peer is used. A successful verification using data from the certificate can allow the tunnel to be established. For instance, if the public key obtained from the Blockchain is validated against the public key provisioned in the peer entity using TEAP Phase 1 procedures, then the secure tunnel is established between the peer entity and the TEAP server in operation 205. Subsequently a TLS renegotiation can be used to transmit the peer entity credentials in the protected and secure tunnel that has been previously established in operation 205. Restated, operation 205 establishes the secure tunnel that is used to communicate authentication related data in the later operations of process 200, thereby providing a safe and tunneled authentication procedure. Within this secure tunnel, TLV objects are used, in accordance with EAP standards, to convey the authentication-related data between the peer entity and the TEAP server. Operation 205 can include elements and operations as consistent with Phase 1 procedures of the TEAP standard that are not specified herein for purposes of brevity.

Next, the process 200 can proceed to operation 206 where a DID corresponding to the authentication server (e.g., auth server) is provided. This allows the peer entity to be aware of the authentication server to which its credentials are being submitted to. TEAP uses TLV objects for conveying the authentication-related data, as alluded to above. Accordingly, operation 206 can involve using the authority identity TLV object (Authority-ID-TLV) to provide the identity of the authentication server. In TEAP, authority identity TLV objects (Authority-ID-TLV) include the identity of the authentication server to help the peer entity match the particular credentials that are available for the identified authentication server. Also, since process 200 utilizes DID as the form of self-sovereign identify, the authority identity TLV object (Authority-ID-TLV) can include the DID of the TEAP server in the object as the identifier for the authentication server.

At operation 207, a DID request can be transmitted to the peer entity. For example, the TEAP server can transmit a request to the peer entity, prompting the peer entity to provide its identity, or DID, as a credential for authentication. The TLV object used in operation 207 can be the identity type TLV object (Identity-Type-TLV). The identity type TLV object (Identity-Type TLV) allows an authentication server, such as a TEAP server, to send a hint to help the peer entity select the right type of identity to submit for authenticating to that particular server, which is the DID in process 200. Thus, operation 207 is referred to as the DID request. Often times, the identity type TLV object (Identity-Type-TLV) is presented in a TEAP request packet.

Thereafter, if the peer entity does have an identity corresponding to the identity type requested (e.g., DID) by the TEAP server in operation 207, then the peer entity will respond with an identity type TLV object (Identity-Type-TLV) including the requested type of identity. In other words, after receiving the DID request transmitted from the TEAP server, the peer entity can send a DID response with its provisioned DID. Subsequently, the TEAP server receives the DID response from the peer entity in operation 208. The DID response may communication in operation 208 as a TEAP response packet including the identity type TLV object (Identity-Type-TLV). Consequently, the DID received in operation 208 serves as a credential provided by the peer entity that is self-sovereign, and can be used for authentication.

In response to successfully receiving the DID response from the peer entity in operation 208, the process 200 can continue to operation 209. At operation 209, the TEAP server can fetch a DID document (also referred to herein as a DID doc) that corresponds to the peer entity form the Blockchain. The DID document can include information that is particularly pertinent to the peer, such as its DID, a device type, attributes, and the like. In an embodiment, the TEAP server sends a “Get DID Doc” request to the Inner EAP server, which is then forwarded to the Blockchain. The DID document may reside on the distributed ledger of the Blockchain, being linked to a particular peer entity by its DID, or submitted credential. Once the DID document that particularly corresponds to the DID of the peer entity to be authenticated (e.g., DID received in operation 208) is obtained from the Blockchain, then the TEAP server receives the DID document at operation 210 in response to the “Get DID doc” request. Operation 210 can involve the DID document being initially obtained by the Inner EAP server, and forwarded to the TEAP server. The TEAP server can receive the DID document and authorization information relating to the peer entity in operation 210.

Thereafter, at operation 211, the TEAP server can inspect the DID document for validating the peer entity using the DID, in order to take an authentication position on the peer entity (including the roles and permissions available to the peer entity). Operation 211 can include a check to determine that the DID received from the peer entity is indeed valid. For example, if the DID of the peer entity that is obtained directly from the peer in previous operation 208 matches the DID of the peer entity as maintained by the Blockchain (obtained by the DID documents), then the DID for the peer is valid, and the peer entity authenticated and the process 200 continues. In other words, upon determining that the DID corresponding to the peer entity is successfully validated, the peer entity is determined to be successfully authenticated.

Otherwise, if the DID for the peer entity is not validated, as indicated by the DID obtained by the peer entity failing to match the DID on the Blockchain, then authentication is failed in operation 212. In some cases, operation 212 can include additional attempts to authenticate the peer entity prior to failing authentication. For example, the TEAP server can proceed with requesting another credential type, or simply apply the network policy based on the configured policy. Failing the authentication may involve the TEAP server communicating a Result TLV indicating “Failure.” In accordance with TEAP, the Result TLV provides support for acknowledged success and failure messages for protected termination within TEAP.

Generally speaking, validation of the peer's DID that is performed in operation 211 is similar to authentication methods that validate credentials submitted by a client, such as a username and password. However, in process 200, the credential is the self-sovereign identity functioning as a Blockchain construct.

Referring now to FIG. 2B, the process continues to operations 213-214 where TEAP session keys are calculated. As a general description, operations 213-214 involve calculating keys that will be used by the peer in a session, as a result of being successfully authenticated. At operation 213, key information for calculating a session key using server data is transmitted to the peer entity. For example, the TEAP server can transmit a server generated random seed, which is encrypted with the peer entity's public key (maintained within the DID document). The information may be communicated in the form of an EAP payload object (EAP-Payload-TLV-BC). Then, using the information transmitted to the peer entity in operation 213, the peer entity can calculate a key. In turn, at operation 214, the TEAP server can receive information for calculating a session key using peer data. The information received by the TEAP server in operation 214 can include a peer generated random seed, which is encrypted with the server's public key (maintained within the DID document). Operation 214 can also involve communicating the information in an EAP payload object (EAP-Payload-TLV-BC). Consequently, the TEAP server can calculate a key using information from operation 214, in addition to the key calculated by the peer entity using information in previous operation 213.

Next, at operation 215, the TEAP server can communicate a crypto-binding TLV object (Crypto-Binding TLV). Accordingly, operation 215 can involve performing a cryptographic binding after the successful EAP method and authentication of the peer entity. In accordance with TEAP, the crypto-binding TLV object (Crypto-Binding TLV) is used to prove that both the peer and server participated in the tunnel establishment and sequence of authentications. The crypto-binding TLV object (Crypto-Binding TLV) can also provide verification of the TEAP type, version negotiated, and outer TLVs exchanged before the TLS tunnel establishment. Also, in TEAP standards, Phase 2 typically ends with a Crypto-Binding TLV exchange and a protected termination exchange.

Subsequently, process 200 can move to operation 216 where a role derivation for the peer entity, and other authorization related capabilities are determined. The roles allowed for the peer entity can be based on information regarding the peer in the DID document (obtained from the Blockchain) and further from internal policies. As an example, the DID document can include attributes, where the attributes are used to further determine which roles have been assigned to the peer entity (and its associated user) in the network. Also, operation 216 includes an EAP success. For example, after the final Result TLV exchange, the TLS tunnel is terminated, and a cleartext EAP Success or EAP Failure is sent by the server. After this EAP success, the role derivation for the peer entity can take place. The roles that are determined for the peer entity can be provided, or otherwise communicated to, the authenticated peer. Also, the peer's roles can be communicated to other network device, such as a WAP or switch. It should be appreciated that roles derived in operation 216 function substantially similar to roles commonly used in authorization, controlling the peer's access to certain services, data, and devices that are available on the commination network.

Thus, the techniques and systems disclosed herein leverage Blockchain and self-sovereign identity within a TEAP framework to achieve network authentication (e.g., EAP authentication). Self-sovereign identity and DID allow personal identifiable information can be abstracted away in a manner that provides an extra layer of security during authorization. For example, an end user may only need to provide proof that it has possession of a public key and private key corresponding to its DID for network authentication, which circumvents the need to divulge the actual identity of the end user as credentials.

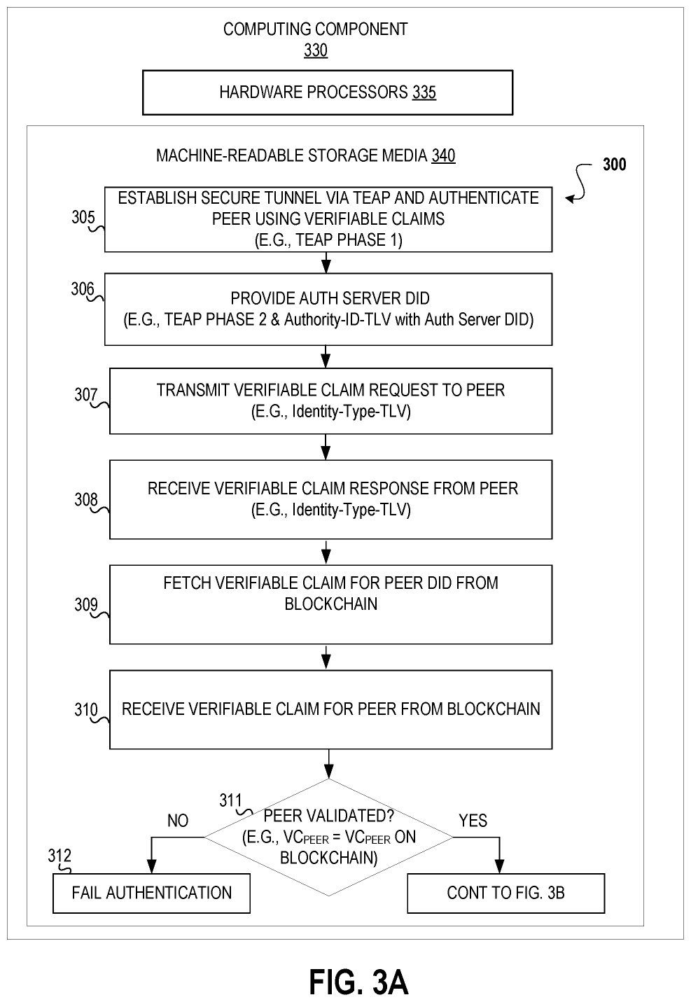

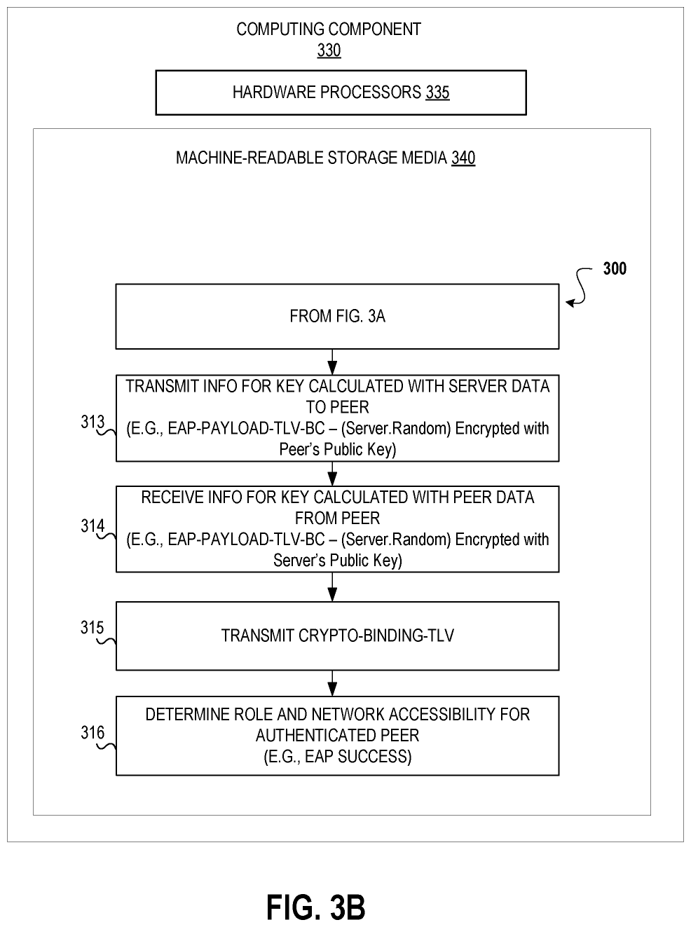

There are other forms of self-sovereign identities, or distributed identities, that may be used as credentials in accordance with the network authentication techniques disclosed herein. To this end, FIGS. 3A-3B depict another example of a process 300 for authenticating a peer entity for network access that particularly employs verifiable claims (as oppossed to DID in the process illustrated in FIGS. 2A-2B). In general, verifiable claims can be considered a layer built on the distributed identity framework. That is, multiple verifiable claims can be associated with a DID. As an example, an entity having a DID can have several attributes, where each attribute can then serve as the context around a separate verifiable claim. It should be appreciated that there are operations in process 300 that are substantially similar in function and arrangement to the network authentication process described in detail above in reference to FIGS. 2A-2B. Accordingly, these operations are not described in detail again with respect to process 300, for purposes of brevity.

Process 300 may begin in FIG. 3A at operation 305, where a secure tunnel is established using the TEAP standard. Generally, operation 305 can establish the secure tunnel using a procedure that is similar to Phase 1 operations currently defined in the TEAP standard as previously described. Also, in operation 305, it can be determined that the peer entity is providing verifiable claims as the form of self-sovereign identity to perform the network authentication process 300. For example, the TEAP server can query the peer entity to send an indicator which reflects the type of self-sovereign identity that it will submit to be authenticated. In response, an indicator can be received and processed by the TEAP server such that the server becomes aware the peer entity will provide verifiable claims as a credential for authentication. Based on this determination, the TEAP server can be configured to implement a verifbale claim-based authentication procedure.

Next, the process 300 can proceed to operation 306 where a DID corresponding to the authentication server (e.g., auth server) is provided. Operation 206 can involve using the authority identity TLV object (Authority-ID-TLV) to provide the DID of the authentication server, which can the TEAP server.

Thereafter, since the peer has already indicated that it will submit a verifbale claims as its credential for authentication, the TEAP server sends a verifiable claim request to the peer entity at operation 307. The TLV object used in operation 307 can be the identity type TLV object (Identity-Type-TLV).

After successfully receiving the verifiable claim request transmitted from the TEAP server, the peer entity can send a verifiable claim response back to the TEAP server. This verifbale claim response can include a verifiable claim corresponding to the peer (and its user). As an example, in a scenario where the network is provided by a University, a verifiable claim suitable for authentication may be “I am a student at the University.” The verifiable claim can be in the form of a signed digital certificate. Subsequently, the TEAP server receives the verifiable claim response from the peer entity in operation 308. The verifiable claim response received by the TEAP server in operation 308 can be a TEAP response packet including the identity type TLV object (Identity-Type-TLV). As a result, the verifiable claim received in operation 308 from the peer entity serves as a credential that is self-sovereign, and can be used for authentication. Moreover, the verifiable claim response can include a particular address that corresponds to a location on the Blockchain where that verifiable claim is maintained. Thus, using the address received in the verifiable claim response, the TEAP server will be able to locate and obtain the corresponding verifiable claim that is on the Blockchain.

Next, at operation 309, the TEAP server can fetch the verifiable claim that corresponds to the peer entity from the Blockchain. As described above, the TEAP can receive an address for the peer's verifiable claim that conveys the location of the verifiable claim on Blockchain. In an example, the TEAP server sends a “Get verifiable claim at address” request to the Inner EAP server, which is then forwarded to the Blockchain to extract the verifiable claim at a location indicated by this address. As alluded to above, verifiable claims can be maintained by the distributed ledger on the Blockchain, where records on the distributed ledger are addressable. Then, in response to the verifbale claim request, the verifiable claim that particularly corresponds to the peer entity is obtained by the TEAP server from the Blockchain in operation 310. In some cases, operation 310 can involve the verifiable claim being initially obtained by the Inner EAP server, and then forwarded to the TEAP server. In some instances, a hash of the verifiable claim is maintained on the Blockchain (as oppossed to the entire verifiable claim), and thereby retrieved from the Blockchain.

After the TEAP server receives the verifiable claim for the peer entity that is on the Blockchain, the verifbale claim can be validated. At operation 311, a check is performed to determine whether the verifiable claim is valid. Operation 311 can include comparing the verifiable claim received from the peer entity in prior operation 308 with the verifiable claim obtained from the Blockchain at operation 310.

Therefore, operation 311 can determine that the verifiable claim received from the peer entity is indeed a valid credential for being allowed access to the communication network. For example, if the verifbale claim of the peer entity that is obtained directly from the peer in previous operation 308 matches the verifiable claim for the peer entity as maintained by the Blockchain in operation 310, then the verifbale claim is considered to be verified as valid. As a result of successfully validating the verifiable claim, the peer entity is authenticated and the process 200 continues. Restated, the verifiable claim provides a context to be verified as a credential by the TEAP server in order for the peer entity to gain network access, rather than providing personal identifying information like a name or password in many existing authentication schemes. Referring back to the example where the peer submits the verifiable claim stating “I am a student of the University”, then the TEAP server can verify whether this verifiable claim is valid and that the end user is verified as a student at the University based on the information that is on the Blockchain. Accordingly, in this example, authentication is based on the context surrounding having a particular relationship with the University, and it being inferred that this relationship allows a user to access the University's network and services.

Otherwise, if the peer is not validated, as indicated by the verifiable claim obtained by the peer entity failing to match the verifiable claim on the Blockchain, then authentication is failed in operation 312 based on this credential. Referring yet again to the example, where the peer submits the verifiable claim stating “I am a student of the University”, the TEAP server may determine that this verifiable claim is invalid. That is, the end user cannot be verified as a student at the University based on the information that is on the Blockchain. Therefore, due to the peer failing to be authenticated at operation 312 with respect to the context of having a proper relationship with the University (e.g., being a student at the University), then the peer entity is not granted access to the University's communication network, for example a secure LAN.

Referring now to FIG. 3B, the process 300 continues to operations 313-314 where TEAP session keys are calculated. At operation 313 the TEAP server can transmit information for a key to be calculated using server data. Operation 313 can involve the TEAP server communicating a server generated random seed, which is encrypted with the peer entity's public key (maintained within the DID document). The information may be communicated in the form of an EAP payload object (EAP-Payload-TLV-BC). Then, using the information transmitted to the peer entity in operation 313, the peer entity can calculate a key.

Then, at operation 314, the TEAP server can receive information for calculating a session key using peer data. The information received by the TEAP server in operation 314 can include a peer generated random seed, which is encrypted with the server's public key (maintained within the DID document). Operation 314 can also involve communicating the information in an EAP payload object (EAP-Payload-TLV-BC).

At operation 315, the TEAP server can communicate a crypto-binding TLV object (Crypto-Binding TLV). Accordingly, operation 315 performs a cryptographic binding after the successful EAP method and authentication of the peer entity.

Subsequently, after the EAP success, the process 300 moves to operation 316 where a role derivation for the peer entity, and other authorization related capabilities are determined. The roles are derived based on information about the peer from the verifiable claim signed by the known issuer. The roles that are determined for the peer entity can be provided, or otherwise communicated to, the authenticated peer. Thus, the techniques and systems disclosed herein leverage verifiable claims within the widely recognized TEAP framework to achieve network access (e.g., EAP authentication). As previously discussed, verifiable claims can be attributes that are predominately pseudonymous, and which enables a type of zero knowledge authentication.

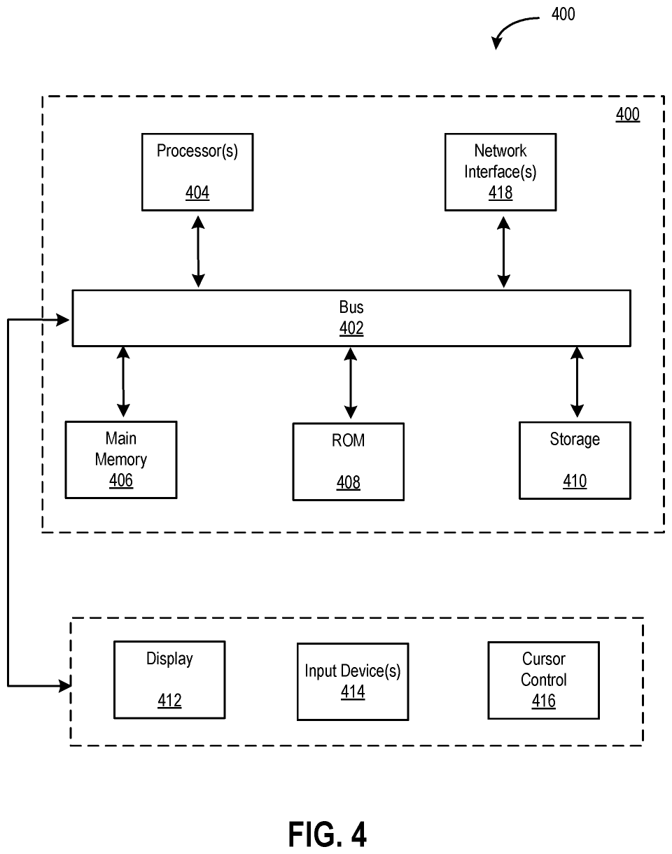

FIG. 4 depicts a block diagram of an example computer system 400 in which the disclosed techniques for self-sovereign identity-based network authentication may be implemented. For example, the computer system 400 may be embedded inside of the Blockchain IoT device, as described above, or any other component or subsystem. Furthermore, it should be appreciated that although the various instructions are illustrated as being co-located within a single processing unit, in implementations in which processor(s) includes multiple processing units, one or more instructions may be executed remotely from the other instructions.

The computer system 400 includes a bus 402 or other transmission mechanism for communicating information, one or more hardware processors 404 coupled with bus 412 for processing information. Hardware processor(s) 404 may be, for example, one or more general purpose microprocessors.

The computer system 400 also includes a main memory 406, such as a random access memory (RAM), cache and/or other dynamic storage devices, coupled to bus 402 for storing information and instructions to be executed by processor 404. Main memory 406 also may be used for storing temporary variables or other intermediate information during execution of instructions to be executed by processor 404. Such instructions, when stored in storage media accessible to processor 404, render computer system 400 into a special-purpose machine that is customized to perform the operations specified in the instructions.

The computer system 400 further includes a read only memory (ROM) 408 or other static storage device coupled to bus 402 for storing static information and instructions for processor 404. A storage device 410, such as a magnetic disk, optical disk, or USB thumb drive (Flash drive), etc., is provided and coupled to bus 402 for storing information and instructions.

The computer system 400 may be coupled via bus 402 to a display 412, such as a, e-ink or liquid crystal display (LCD) (or touch screen), for displaying information to a computer user. The computer system 400 may include other input/output devices, such as speakers, microphones, and the like for enabling audio and/or voice for input and output of information, data, and commands. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. In some embodiments, the same direction information and command selections as cursor control may be implemented via receiving touches on a touch screen without a cursor.

The computing system 400 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor(s) 404 executing one or more sequences of one or more instructions contained in main memory 406. Such instructions may be read into main memory 406 from another storage medium, such as storage device 410. Execution of the sequences of instructions contained in main memory 406 causes processor(s) 404 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 410. Volatile media includes dynamic memory, such as main memory 416. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 402. Transmission media can also take the form of acoustic or light waves, such as those generated during radio-wave and infra-red data communications.

The computer system 400 also includes a communication interface 418 coupled to bus 402. Network interface 418 provides a two-way data communication coupling to one or more network links that are connected to one or more local networks. For example, communication interface 418 may be an integrated services digital network (ISDN) card, cable modem, satellite modem, or a modem to provide a data communication connection to a corresponding type of telephone line. As another example, network interface 418 may be a local area network (LAN) card to provide a data communication connection to a compatible LAN (or WAN component to communicate with a WAN). Wireless links may also be implemented. In any such implementation, network interface 418 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 418, which carry the digital data to and from computer system 410, are example forms of transmission media.

The computer system 400 can send messages and receive data, including program code, through the network(s), network link and communication interface 418. In the Internet example, a server might transmit a requested code for an application program through the Internet, the ISP, the local network and the communication interface 418.

The received code may be executed by processor 404 as it is received, and/or stored in storage device 410, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 500.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method, comprising:
establishing a secure tunnel to a peer entity via Tunnel Extensible Authentication Protocol (TEAP), wherein the secure tunnel is used for an exchange of data during authentication of a peer entity for access to a communication network;
transmitting a request to the peer entity for a distributed identity (DID) corresponding to the peer user or element via the secure tunnel, wherein the DID corresponding to the peer entity serves as a credential for authentication of the peer entity;
receiving a response to the request from the peer entity, wherein the response includes the DID corresponding to the peer user or element; and
determining whether the peer entity is successfully authenticated for access to the communication network based on the received DID corresponding to the peer entity.

2. The method of claim 1, wherein transmitting a request to the peer entity for a DID corresponding to the peer entity is in response to receiving an indication that the peer entity is providing a DID to serve as a credential for authentication for access to a communication network.

3. The method of claim 1, wherein the request to the peer entity for a DID corresponding to the peer user or element is formatted as an Authority-ID-TLV object in accordance with TEAP.

4. The method of claim 1, wherein the response from the peer entity is formatted as an Authority-ID-TLV object in accordance with TEAP.

5. The method of claim 2, wherein determining whether the peer entity is successfully authenticated comprises:
upon determining that the DID corresponding to the peer entity is successfully validated, determining that the peer entity is successfully authenticated.

6. The method of claim 5, wherein determining that the DID corresponding to the peer entity is successfully validated comprises:
fetching a DID document corresponding to the peer entity from a Blockchain network, wherein the DID document comprises a Blockchain DID corresponding to the peer entity;
comparing the Blockchain DID corresponding to the peer entity peer entity received via the response from the peer entity; and
determining that the Blockchain DID corresponding to the peer entity matches the DID corresponding to the peer entity received via the response from the peer entity.

7. The method of claim 6, wherein comprises:
providing a Decentralized identity (DID) corresponding to an authentication server.

8. The method of claim 7, further comprising:
in response to determining that the peer entity is successfully authenticated, calculating session keys using a first public key corresponding to the peer entity and a second public key corresponding to a authentication server.

9. The method of claim 8, wherein the DID document corresponding to the peer entity fetched from the Blockchain network comprises the first public key corresponding to the peer entity and the second public key corresponding to the authentication server.

10. The method of claim 6, comprising:
determining a role corresponding to the peer entity, wherein the role is associated with authorization to access services and devices via the commination network for the peer entity.

11. The method of claim 10, wherein the role corresponding to the peer entity is determined based on information in the DID document corresponding to the peer entity fetched from the Blockchain network.

12. A Blockchain Internet-of-things (IoT) system, comprising:
a Blockchain IoT device acting as a peer requesting authentication for access to a communication network, wherein the Blockchain IoT device comprises a verifiable claim embedded thereon;
an wireless access point (WAP) acting as an authenticator providing access to the communication network for the Blockchain IoT device upon successfully authenticating the Blockchain IoT device;
a Blockchain network coupled to the Blockchain IoT device and the WAP; and
an authentication server supporting Tunnel Extensible Authentication Protocol (TEAP) and coupled to the Blockchain IoT network, wherein the authentication server is configured to:
establish a secure tunnel to the Blockchain IoT device acting as the peer via TEAP, wherein the secure tunnel is used for an exchange of data during authentication of the peer for access to the communication network;
transmit a request to the peer for a verifiable claim corresponding to the peer via the secure tunnel, wherein the verifiable claim corresponding to the peer serves as a credential for authentication of the peer;
receiving a response to the request from the peer, wherein the response includes the verifiable claim corresponding to the peer and an address corresponding to a location of the verifiable claim on the Blockchain network; and
determining whether the peer is successfully authenticated for access to the communication network based on the received verifiable claim corresponding to the peer.

13. The system of claim 10, wherein the Blockchain IoT device comprises at least one of: a laptop, a tablet computer, a mobile computing device, an autonomous system, an IoT device or a smartphone.

14. The system of claim 11, wherein the authentication server is coupled to the Blockchain network via an Inner Extensible Authentication Protocol (EAP) server.

15. The system of claim 12, wherein the authentication server is further configured to:
receive an indication that the peer entity is providing a verifiable claim to serve as a credential for authentication for access to a communication network.

16. The system of claim 15, wherein the request to the peer entity for the verifiable claim corresponding to the peer entity is formatted as an Authority-ID-TLV object in accordance with TEAP.

17. The system of claim 16, wherein the response from the peer entity is formatted as an Authority-ID-TLV object in accordance with TEAP.

18. The system of claim 15, wherein the authentication server comprises a TEAP server.

19. The system of claim 12, wherein the authentication server is further configured to:
determine that the peer entity is successfully authenticated, in response to determining that the verifiable claim corresponding to the peer entity is successfully validated.

20. The system of claim 19, wherein the authentication server is further configured to:
fetch a Blockchain verifiable claim corresponding to the peer entity from a Blockchain network using the address corresponding to the location of the verifiable claim on the Blockchain network;
compare the Blockchain verifiable claim corresponding to the peer entity to the verifiable claim corresponding to the peer entity received via the response from the peer entity;
determine that the Blockchain verifiable claim corresponding to the peer entity matches the verifiable claim corresponding to the peer entity received via the response from the peer entity; and
in response to determining the match, determine that the verifiable claim corresponding to the peer entity is successfully validated.
